(19) United States
(12) Patent Application Publication
(10) Pub. No.: US 2016/0113842 A1
(43) Pub. Date: Apr. 28, 2016

(54) NEUROPHYSIOLOGICAL METHOD OF TREATING A NEUROLOGICAL DISORDER

(71) Applicant: Marissa Everly Clark, Lawrence, KS (US)

(72) Inventor: Marissa Everly Clark, Lawrence, KS (US)

(21) Appl. No.: 14/520,823

(22) Filed: Oct. 22, 2014

(51) Int. Cl. A61H 39/04

(52) U.S. Cl. CPC A61H 39/04

(57) ABSTRACT

A neurophysiological method of treating muscular dysfunction caused by a neurological disorder, such as Parkinson's Disease, includes applying a predetermined pressure to the patient, so as to cause pain inhibition that blocks response to a targeted muscle at the spinal cord level, and translating the patient through a passive range of motion, while causing the pain.

### BACKGROUND OF THE INVENTION

1. Field of the Invention

The present disclosure generally relates to methods of physical therapy and techniques for treating patients having neurological disorder, such as Parkinson's disease (Parkinson's or “PD”); and more particularly, to a neurophysiological method of treating muscular dysfunction in such patients, which involves producing pain inhibition, while taking the patient through a passive range of motion.

2. Background Art

Parkinson's disease is the second most common neurological disorder, and is caused in part by a degeneration of the dopamine producing cells of the substantia nigra. This chemical facilitates communication between the brain and muscles of the body, and more particularly, between the primary motor cortex and the spindles that lie within the muscles. With particular respect to the present invention, it is appreciated that each spindle functions, under normal conditions, to inform the brain of the contraction state and length of the muscle, as well as to activate motoneurons that resist muscle stretch. Where miscommunication occurs between the brain and spindle, as a result of a neurological disorder, such as Parkinson's, for example, the muscle becomes unable to function properly.

As the prevalence of Parkinson's increases with the rise in median age, so to does the need for clinicians to understand the complexities of motor and non-motor impairments that arise therefrom. Studies show that those with Parkinson's suffer from abnormal kinesthesia (i.e., the sense that detects bodily position, weight, or movement of the muscles, tendons, and joints) and use of proprioception (i.e., the unconscious perception of movement and spatial orientation). That is to say, these individuals have an impaired ability to detect their own motion, such as the rotation of a body surface or the passive rotation of their joints.

As a result, these patients typically exhibit a decreased response to muscle vibration, bradykinesia (i.e., extreme slowness of movement and reflexes), an over-estimation of body motion, and an over-dependence on vision. Beyond the noticeable tremors, and rigidity, Parkinson's presents a variety of correlated symptoms and ailments. For example, it is appreciated that muscular rigidity increases muscle tension, and shortening, which in turn, cause postural instability, and “masking” of facial muscles (i.e., hypomimia). Other symptoms include depression, emotional changes, difficulty swallowing and chewing, speech changes, dementia, sleep disturbances, olfactory loss, urinary problems, and constipation, which may vary in severity from patient to patient.

Conventional physical therapy has been applied to Parkinson's patients with moderate, and often short-term results. That is to say, after seeing an instantaneous improvement, such patients typically continue to suffer from a worsening disability, and noticeable symptoms over time. Moreover, conventional drug treatments also present concerns. It is appreciated, for example, that certain medications composing the current standard of care often worsen other symptoms, or may cause side effects, while addressing the targeted symptom. Also, depending upon the symptom, drug therapy may be ineffective all together. For example, it is appreciated that bradykinetic postural responses in patients with PD generally are not improved by antiparkinsonian medications, highlighting the need for an exercise approach to this constraint on mobility. Even where efficacious, the period of effectiveness from each dose typically begins to shorten, under what is known as the wearing-off effect.

### BRIEF SUMMARY

The present invention concerns a method of treating a patient with muscular dysfunction due to Parkinson's disease (or like neurological disorder), which employs pain inhibition to block motor response in a targeted muscle at the level of the spinal cord. The method has been shown to effect substantially greater physiological improvement in patients with mild to severe ailments, in comparison to conventional therapy. By blocking the motor response, the invention is useful for allowing the afflicted muscle to reset the spindle to a greater length than before, so that the manipulated joint is able to regain a normalized active range of motion; and the speed by which the method is performed is further useful to retrain the mechanoreceptors of the muscle. Thus, the method effectively treats symptoms associated with Parkinson's, including bradykinesia, rigidity, and the pain associated therewith. It further helps with compromised balance, endurance, and mobility, which reduces fall risk that not only delays the pain, suffering, and medical costs associated with an injurious fall, but also delays the loss of independence and reduces healthcare expenses. The method is yet further useful for providing treatment from a neurophysiological standpoint, which directly reconditions the muscle's ability to communicate. Lastly, as a preferably manual solution, the method is readily implemented and adaptable in the existing treatment plans of clinicians and other licensed professionals.

Thus, the invention generally concerns a neurophysiological method of treating a neurological disorder resulting in muscular dysfunction in a patient. The method comprises the steps of accessing at least one muscle presenting a dysfunctional condition caused by the disorder, and applying a predetermined pressure to the patient at a targeted location, such as the muscle, so as to cause the patient pain at the spinal cord level. The pain is operable to block motor response to said at least one muscle. Finally, the patient is taken through a passive range of motion, such that the muscle is manipulated, while causing the pain.

Other aspects and advantages of the present invention, including initial assessment, and post treatment follow-up regiments will be apparent from the following detailed description of the preferred embodiment(s) and the accompanying drawing figures.

### BRIEF DESCRIPTION OF THE SEVERAL VIEWS OF THE DRAWING

A preferred embodiment(s) of the invention is described in detail below with reference to the attached drawing figures of exemplary scale, wherein:

FIG. 1 is an elevation of a Quadratus Lumborum (QL) muscle group;

FIG. 2 is an elevation of a patient lying supine, and a clinician applying treatment to the QL of the patient, in accordance with a preferred embodiment of the invention;

FIG. 2a is another elevation of a patient lying supine, and a clinician applying a second manner of treatment to the QL of the patient, in accordance with a preferred embodiment of the invention;

FIG. 3 is an elevation of the Posterior Tibialis (PT);

FIG. 4 is an elevation of a patient lying prone, and a clinician applying treatment to the PT of the patient, in accordance with a preferred embodiment of the invention;

FIG. 5 is an elevation of a patient lying supine, and a clinician applying treatment to the shoulder of the patient, in accordance with a preferred embodiment of the invention; and

FIG. 6 is an elevation of a patient's face, having adhesive tape applied thereto as part of a post-treatment regiment, in accordance with a preferred embodiment of the invention.

### DETAILED DESCRIPTION

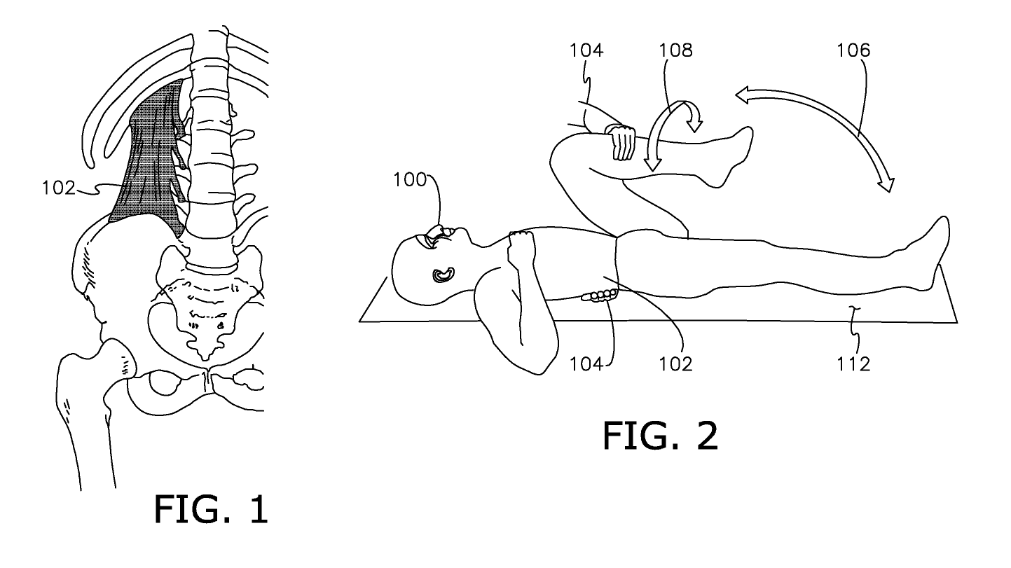

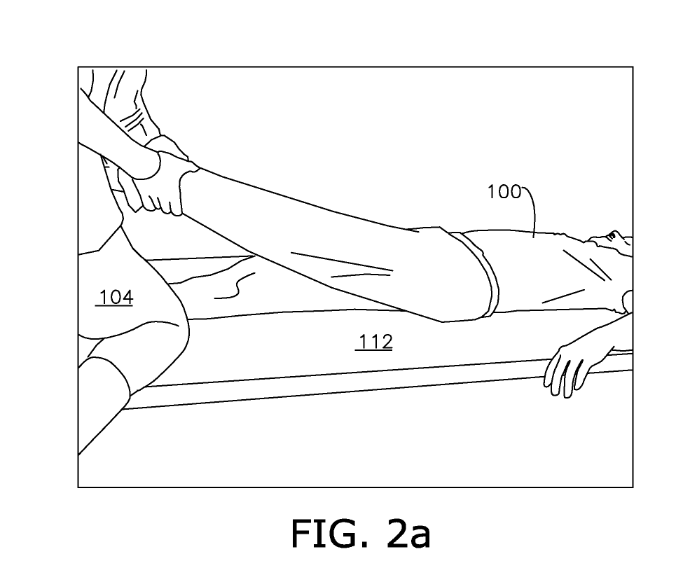

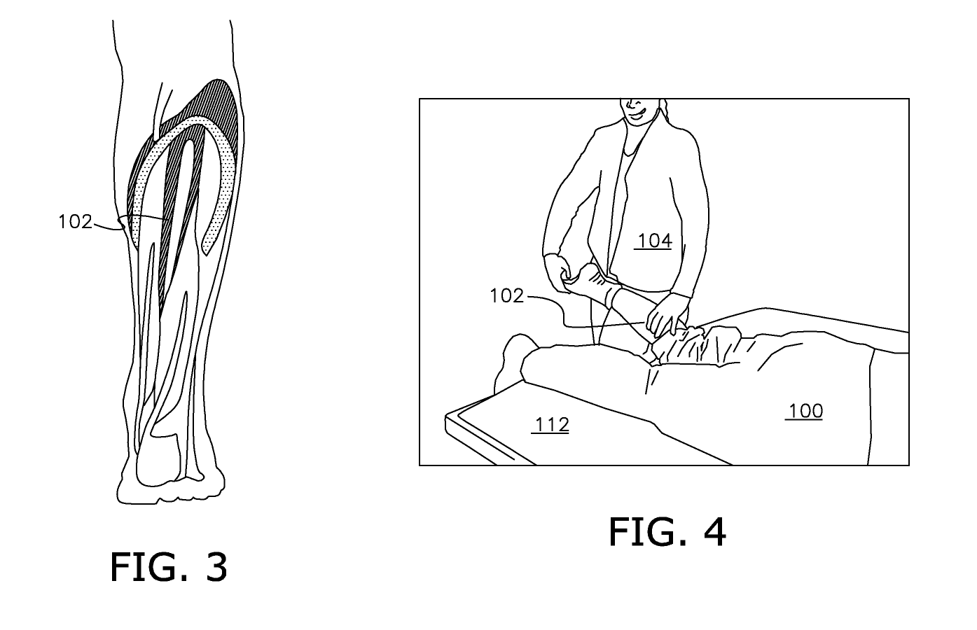

The following description of the invention is merely exemplary in nature and in no way intended to limit the disclosure, its application, or uses. In general, the present invention provides a method of treating a patient 100 (FIGS. 2, 2a, 4 to 6) suffering from a neurological disorder, such as Parkinson's disease, that impacts muscular responsiveness and communication. Though described and presented with respect to Parkinson's, it is appreciated that the method may be used to treat muscular dysfunction due to other neurological disorders or conditions where applicable (e.g., Dystonia, Multiple Sclerosis, etc.). The method generally employs pain inhibition to block motor response in a targeted muscle 102 (FIGS. 1, 3) at the spinal cord level, so as to alleviate and counteract the affects of the disorder. That is to say, by generating pain through predetermined pressure applied at targeted locations, motor response is inhibited at the level of the spinal cord. The inhibition temporarily discontinues communication with the spindle (not shown), which allows the muscle 102 to stretch without improper neurological commands instructing it to contract, and thereby, reset its functional length. Producing a predetermined passive range of motion (PROM) in the patient, preferably along multiple planes (FIG. 2), during the inhibition retrains the mechanoreceptors (also not shown) of the muscle 102, thereby allowing the patient to achieve normalized active range of motion about the affected joint.

The method is preferably manually administered; however, it is certainly within the ambit of the invention to automate any step or portion thereof. It is appreciated that the invention may be used to treat mild to severe Parkinson's. By increasing joint range of motion and speed about the hip, for example, the inventive method has been shown to significantly improve balance and gait. In an exemplary sample of patients, hip range of motion increased by 90%, single leg stance time (a measure of fall risk) increased from 5 to 16 seconds, and the improvements were maintained one month post-therapy.

In a first aspect of the invention, joint rigidity caused by at least one improperly functioning muscle group is addressed. In this regard, the method generally starts by instructing the patient 100 to perform an active range of motion (AROM) that reflects the degree of rigidity about the afflicted joint. The pre-release range of motion about the joint is assessed and recorded. The patient 100 is then preferably positioned to allow access to the muscle(s) 102 causing the rigidity (FIGS. 2, 4, and 5). To produce motor response blockage, pressure is applied to a body part sharing a neural pathway at the spinal cord level with the muscle 102 (FIG. 2a), and more preferably, directly to the muscle 102 (FIG. 2).

Pressure is applied by first palpating the muscle 102, and then bearing upon the skin and other soft tissue structures that overly the muscle or targeted location. The muscle pressure is preferably applied to a point of Resistance 2 (R2), which is understood by those of ordinary skill in the art to mean the first encountered barrier that resists soft tissue movement, or the point at which all available slack in the overlying tissue and muscle has been taken up. When palpating, the clinician 104 should feel a hardening of the tissue as R2 resistance is approached; the clinician 104 should also notice an increase in pain in the patient 100. It is appreciated that the barrier should be located before the normal range of motion is determined, so as to avoid applying pressure that takes the soft tissue above its normal range, and thereby, causing tissue damage.

Once the proper pressure is applied, the patient 100 should be informed that PROM is about to begin, and instructed to relax. PROM is preferably performed by first taking the patient through a straight plane motion 106 (FIG. 2) that results in the natural contraction and stretching of the targeted muscle 102, until rigidity is sufficiently decreased. It is appreciated that the straight plane motion may be coronal, sagittal, or transverse in direction. As rigidity decreases, it is appreciated that the range of motion increases; at this step the clinician 104 preferably introduces a predetermined speed to the PROM. The speed of motion is increased preferably until emulating normal muscle function, so as to addresses bradykinesia.

Once the joint is taken through the straight plane motion 106 and the range of motion is increased, the manipulated joint is preferably rotated to apply a torsion motion 108 to the muscle (FIG. 2). Torsion is typically applied in the transverse plane. As with the straight plane action, torsion is applied while maintaining pain inhibition, until a full range of rotational motion is passively achieved. For most muscle groups the treatment should last approximately 30-45 minutes. More preferably, two individuals, such as the clinician 104 and an assistant (not shown), may cooperatively perform the technique, as described above.

After the PROM, a post-treatment regiment is preferably performed by the patient over the succeeding 12 to 48 hours, which reinforces the treatment. The regiment preferably includes an exercise that requires the use of the treated muscle through a full range of motion. The regiment may be self-initiated and performed periodically during the period by the patient 100; or where self-actuation is impractical, the regiment, may involve holding the muscle(s) 102 in a fixed state over the period. To that end, adhesive tape, bracing, or other apparatus may be employed to retain the muscle(s) 102 in a desired (e.g., fully stretched) state. To address masking (i.e., rigidity of the facial muscles), for example, it is appreciated that tape 110 may be used over a 12-24 hour period following PROM to maintain the facial muscles 102 (not shown) in an expressive state (FIG. 6) and deter hypomimia. A follow-up reinforcing regiment is particularly applicable where the motion that was attained during PROM was reset via slow adapting mechanoreceptors. With respect to masking, it is appreciated that the tape 110 holds the face in order to reset the Ruffini ending mechanoreceptors over the period of time.

In a non-illustrated application, the method may be applied to release the obturator muscle group, where the straight plane motion may be accomplished by moving the knee in flexion/extension (knee to chest and straightening of the leg). In this application, the method begins with the step of laying the patient upon his or her side. Next, both legs are bent to a 90-90 position at the hips and at the knees. The Obturator Internus is then palpated by accessing the belly of the obturator through the superior portion of the intergluteal fold. Starting towards the superior portion of the gluteal fold, the clinician slides a preferably gloved hand at an upward angle towards the greater trochanter on the side that is up until he or she feels the ischial tuberosity and the obturator foramen. It is appreciated that the obturator originates on the obturator membrane and inserts on the greater trochanter.

Once the muscle belly has been palpated, the clinician imparts the amount of force thereupon necessary to reach Resistance 2, R(2). The clinician (and/or assistant) begins moving the leg through the PROM making sure to take the leg passed the range of motion observed during the pre-release testing. At this point the motion will slow, and resistances to motion will increase. It is important that the clinician push passed the pre- release range of motion so as to achieve a release of the tension in the muscle belly. Once resistance is felt and the pre-release threshold is passed the leg is returned to the starting position. More preferably, the leg is taken through 3 planes of motion in order to get a complete release, e.g., FABER or clamshell, hip flexion/extension, and circular motion at the hip (small to large circles). The cycle is then repeated in a slow, controlled manner, causing the resistance to motion to reduce over time and PROM motion to increase. During cycling, the clinician preferably applies pressure along the entire belly of the muscle, and increases the speed of motion, until the muscle has been “released,” full range of motion has been returned to the joint, and there is no more pain.

In the first illustrated embodiment, the method is used to treat the Quadratus Lumborum, i.e., the lateral lower back muscle group 102 extending from the floating rib to the pelvis, and attached to the lumbar vertebrae (FIG. 1). It is appreciated that the QL is a spinal stabilizer, and used in conjunction with the gluteus muscle groups during walking and other activities. The Quadratus Lumborum is innervated by fibers from the ventral rami of the T12 to L3 spinal nerves, which share pathway used by the brain to perceive pain within the legs and lower extremity. As shown in FIG. 2, a preferred application of the inventive method to treat this muscle group starts with the patient 100 lying supine. A clinician 104 preferably applies pressure to the point of Resistance 2, which should produce tolerable pain, and may increase inhibition by applying pressure to the point at the cusp of intolerable pain (without damaging the muscle). The pressure may be applied at a pressure sensitive location, such as the Achilles tendon and flexor/lower calf muscles (FIG. 2a), so as to minimize the pressure necessarily generated and maintained by the clinician 104. More preferably, the pressure is applied to the QL itself by the clinician 104 or a second assistant/clinician (not shown). It is appreciated that the point and location (i.e., proper hand position) is subjectively determined based on several factors, including patient involuntary and/or voluntary (e.g., verbal) feedback, the clinician's experience and training, etc.

Next, the patient 100 is caused to undergo a passive range of motion at a predetermined speed, so as to reset the mechanoreceptors of the muscle, while maintaining the pressure,. In the current application, the clinician 104 may, for example, lift the heel 104 of the patient 100, while the leg is unbent, to stretch the Quadratus Lumborum and provide traction in a straight plane, as shown in FIG. 2a; another manner may involve the lifting of a bent leg such as shown in FIG. 2. The straight plane motion 106 may be performed by lifting the foot up and down. Once rigidity about the hip is decreased, and the speed of straight plane motion is increased to a predetermined degree (e.g., at least 50%, and more preferably, 100%), transverse plane rotational motion 108 is performed by lifting the hip off the support surface 112, so as to twist the lower torso and torsionally stretch the QL. The pain perceived during PROM blocks motor response in the spindle of the Quadratus Lumborum, which allows it to stretch without resistance, and reset its functional length. After PROM, the patient 100 is instructed to self-initiate an active range of motion (AROM), such as walking and twisting, that reinforces the PROM, for several sessions over at least a 24-hour period, and more preferably, over a 48 hour period. Performance of these steps has been clinically shown to improve both rigidity and bradykinesia at the QL.

In another example, the method may be applied to treat rigidity and bradykinesia due to Parkinson's within the Posterior Tibialis 102, i.e., the lower posterior leg muscle extending centrally from the calf to ankle (FIG. 3). In this example, the patient 100 lies prone (FIG. 4), while the clinician 104 manually applies pain inducing pressure, for example, to the exterior of the gastrocnemius (i.e., calf). While applying the pressure, the clinician 104 then causes the patient 100 to undergo a passive range of motion about the ankle. For example, the clinician 104 may flex the patient's elevated foot in the fore-aft direction, so as to contract and stretch the muscle 102. The clinician 104 may clamp/pinch the calf using one hand, as the foot is lifted and manipulated with the other (FIG. 4). It is appreciated that the pain induced during stretching blocks motor response in the spindle of the Posterior Tibialis, thereby allowing the muscle 102 to reset its length. In this application, the method results in increase joint range of motion about the ankle, thereby increasing balance.

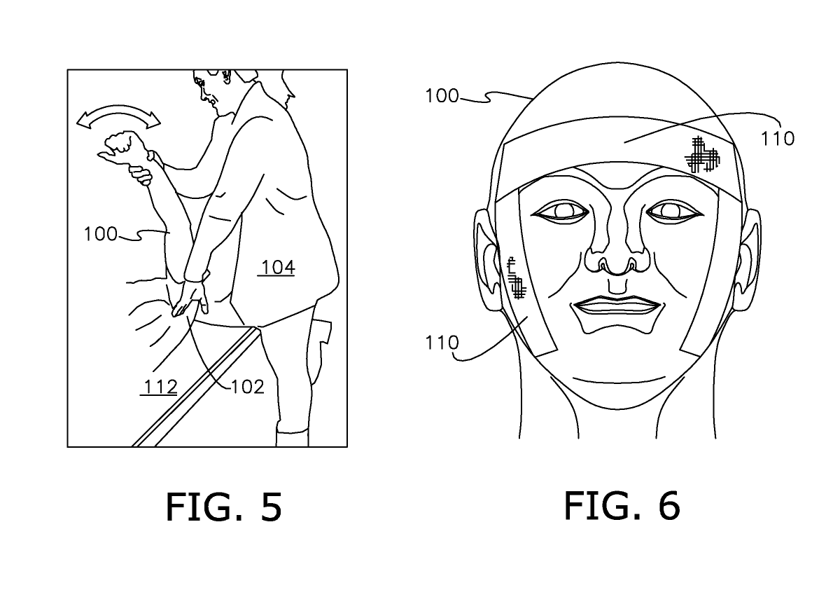

In a fourth example, the method may be used to rehabilitate the shoulder (FIG. 5). In this application, the patient 100 preferably lays supine upon a surface 112, with the afflicted shoulder 102 and arm proximate the edge of the surface. The clinician 104 gains access to the armpit by holding the wrist of the patient 100 and lifting the arm. The clinician applies pressure to the subscapularis (FIG. 5) preferably to the point of Resistance 2, which should cause tolerable pain. As shown, the clinician 104 may spear the infrapinatus with one hand, gaining leverage to apply the pressure (FIG. 5). Once pain inhibition is produced, the clinician 104 takes the arm through a passive range of motion, by manipulating the arm about the shoulder joint. The deltoid may be stretched first in a straight plane motion by folding the arm across the chest and splaying the arm outward and back, and then in a rotational motion, e.g., by rotating the arm in a circle. As previously mentioned, the benefits of PROM while inducing pain include resetting the deltoid spindle, and retraining the mechanoreceptors of the muscle, which addresses rigidity and bradykinesia in the shoulder.

Other rigidity management examples include application of the method to treat the Piriformis, or Gluteal muscles to treat the symptoms of Parkinson's disease, in a similar manner.

As used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. Furthermore, all ranges directed to the same quantity of a given component or measurement is inclusive of the endpoints and independently combinable. This written description uses examples to disclose the invention, including the best mode, and also to enable any person skilled in the art to make and use the invention. The patentable scope of the invention is defined by the claims, and may include other examples that occur to those skilled in the art.

What is claimed is:

1. A neurophysiological method of treating muscular dysfunction caused by a neurological disorder in a patient, said method comprising the steps of:
a) accessing at least one muscle presenting a dysfunctional condition caused by the disorder;
b) applying a predetermined pressure to the patient at a targeted location, so as to cause the patient pain at the spinal cord level, wherein the pain is operable to block motor response to said at least one muscle; and
c) translating the patient through a passive range of motion, so as to manipulate said at least one muscle, while applying the pressure.

2. The method as claimed in claim 1, wherein the disorder is selected from the group consisting of Parkinson's disease, Dystonia, Multiple Sclerosis, and like disorders.

3. The method as claimed in claim 1, wherein the condition is bradykinesia, and step c) is performed at a predetermined speed operable to reduce bradykinesia.

4. The method as claimed in claim 1, wherein step b) further includes the steps of applying the pressure until Resistance 2 is achieved.

5. The method as claimed in claim 1, wherein step b) further includes the steps of applying the pressure directly to said at least one muscle.

6. The method as claimed in claim 1, wherein the condition is rigidity, said at least one muscle defines a functional length, and the passive range of motion is operable to cause the functional length to increase.

7. The method as claimed in claim 6, wherein step a) further includes the steps of assessing said at least one muscle to determine a pre-release range of motion prior to step a), and step c) further includes the steps of translating the patient through a range of motion greater than the pre-release range.

8. The method as claimed in claim 6, wherein step c) further includes the steps of translating the patient through a straight plane motion until rigidity is decreased, and then through a rotational motion.

9. The method as claimed in claim 1, further comprising:
d) manipulating the patient and said at least one muscle over a period after steps b) and c), so as to reinforce the passive range of motion.

10. The method as claimed in claim 9, wherein step d) is performed over a period between 12 and 48 hours.

11. The method as claimed in claim 9, wherein step d) is performed periodically during the period, and includes causing the patient to achieve an active range of motion not less than the passive range of motion.

12. The method as claimed in claim 9, wherein said at least one muscle is a plurality of facial muscles, and step d) further includes the steps of retaining the facial muscles in an achieved state using tape, so as to reset slow adapting mechanoreceptors.

13. A neurophysiological method of treating muscular dysfunction caused by a neurological disorder in a patient, said method comprising the steps of:
a) assessing at least one muscle presenting a dysfunctional condition caused by the disorder;
b) accessing said at least one muscle;
c) applying a predetermined pressure to the patient at a targeted location, so as to cause the patient pain at the spinal cord level, wherein the pain is operable to block motor response to the muscle;
d) causing the patient to undergo a passive range of motion, so as to manipulate the muscle, while causing the pain; and
e) causing, after the passive range of motion, the patient to undergo a follow- up regiment, so as to reinforce the passive range of motion.

14. A neurophysiological method of treating muscular dysfunction caused by Parkinson's Disease in a patient, said method comprising the steps of:
a) assessing at least one rigid muscle, so as to determine a pre-release range of motion;
b) accessing said at least one muscle;
c) applying a predetermined pressure to the patient directly to said at least one muscle, so as to cause the patient pain at the spinal cord level, wherein the pain is operable to block motor response to said at least one muscle;
d) causing the patient to undergo a passive range of motion greater than the pre-release range, so as to manipulate the muscle at a predetermined speed, while causing the pain; and
e) causing, after the passive range of motion, the patient to undergo a follow-up regiment over a period of not less than 12 hours, so as to reinforce the passive range of motion.
